(19) United States
(12) Patent Application Publication
(10) Pub. No.: US 2011/0244154 A1
(43) Pub. Date: Oct. 6, 2011

(54) METHOD AND CYLINDRICAL SEMI-FINISHED PRODUCT FOR PRODUCING AN OPTICAL COMPONENT

(75) Inventors: Thomas Krause, Wolfen (DE); Martin Trommer, Bitterfeld-Wolfen (DE)

(73) Assignee: Heraeus Quarzglas GmbH & Co KG, Hanau (DE)

(21) Appl. No.: 12/998,596

(22) PCT Filed: Oct. 29, 2009
(86) PCT No.: PCT/EP2009/064269

§ 371 Date: Jun. 1, 2011

(30) Foreign Application Priority Data
Nov. 6, 2008 (DE) 102008056084.7

(51) Int. Cl. C03B 37/014; B32B 17/02; G02B 6/036; B32B 1/08

(52) U.S. Cl. 428/34.6; 65/417; 428/392

(57) ABSTRACT

In a known method for producing a dimensionally stable semi-finished product for use in producing fibers from synthetic quartz glass, an SiO₂ soot layer is applied to the outer wall of a quartz glass inner cylinder and is subjected to a sintering treatment, wherein a sintering zone moves through the SiO₂ soot layer from the outside to the inside. In order to achieve dimensionally accurate and low-deformation production as well as high cost efficiency based on said known method, it is proposed that the sintering treatment be interrupted before the sintering zone reaches the outer wall of the inner cylinder so that an intermediate layer made of synthetic quartz glass containing pores remains at the inner cylinder outer wall. The semi-finished product obtained in such a way is elongated into the optical component, wherein the intermediate layer sinters completely into transparent quartz glass.

The present invention relates to a method for producing an optical component by elongating a cylindrical semifinished product of synthetic quartz glass, the method comprising the following steps:
an inner cylinder comprising an outer wall and made of synthetic quartz glass is clad with a SiO₂ soot layer,
the SiO₂ soot layer is subjected to a sintering treatment in which the SiO₂ soot layer is heated from the outside and a sintering zone thereby moves through the SiO₂ soot layer from the outside to the inside while forming an outer layer of transparent quartz glass.

Moreover, the invention is concerned with a cylindrical semifinished product for producing an optical component.

The optical component is an optical fiber or a preform for drawing the optical fiber. The optical fiber to be produced according to the invention is entirely transparent and free of cavities.

### PRIOR ART

Typically, core rods, as are used for producing optical fibers, have a core glass region that is surrounded by an inner, relatively thin cladding glass layer. Further cladding glass is applied either by coating the core rod with synthetic quartz glass or by overcladding the core rod with one or a plurality of hollow cylinders of synthetic quartz glass. In both cases intermediate steps are customary in which porous soot layers of SiO₂ particles are deposited on a substrate body and the soot layer is then sintered to obtain transparent quartz glass that serves as cladding glass in fiber production.

For instance U.S. Pat. No. 6,422,042 A describes a method for producing a semifinished product for making a preform for optical fibers in that a SiO₂ soot layer is applied to the jacket surface of a tube consisting of fluorine-doped quartz glass. A core rod is introduced into the inner bore of the quartz glass tube and the soot layer is subsequently sintered in a hot process and the quartz glass tube is collapsed onto the core rod at the same time.

DE 101 55 134 C discloses a method for producing an optical preform, wherein a porous SiO₂ soot layer is directly deposited on the jacket surface of a core rod rotating about its longitudinal axis. To avoid incorporation of hydroxyl groups into the quartz glass of the core rod, the SiO₂ soot layer is deposited in a hydrogen-free reaction zone, for instance hydrogen-free plasma.

A semifinished product and a method of the aforementioned type are known from WO 2008/071759 A1. For the manufacture of a hollow cylinder composed of quartz glass for use as a semifinished product for fiber production, a method is suggested in which an inner tube of quartz glass is provided with a porous SiO₂ soot layer. The SiO₂ soot layer is subsequently sintered such that the inside of the inner tube remains below the deformation temperature of quartz glass. This is e.g. accomplished in that in the sintering process a coolant is passed through the inner bore of the inner tube.

A hollow cylinder with a smooth inner surface can thereby be produced without any geometric deviations, which cylinder need no longer be subjected to final machining and can directly be used as a semifinished product for fiber production. The method, however, has the disadvantage that considerable amounts of coolant must be used for cooling the inner tube so as to prevent deformation thereof.

### TECHNICAL OBJECT

It is therefore the object of the present invention to provide a method for producing a semifinished product for use in fiber or preform production that offers the advantage of dimensionally accurate and low-deformation production on the one hand and is cost-efficient on the other hand.

Moreover, it is the object of the present invention to provide a semifinished product which is suited for producing optical fibers or preforms and can be produced at low costs and which is distinguished by high dimensional accuracy.

As for the method, this object, starting from a method of the aforementioned type, is achieved in
that the sintering treatment is interrupted before the sintering zone reaches the outer wall of the inner cylinder so that a semifinished product is obtained in which an intermediate layer of pore-containing synthetic quartz glass remains between outer layer and outer wall of the inner cylinder, and
that the semifinished product is elongated into the optical component, with the intermediate layer being completely sintered into transparent quartz glass.

The inner cylinder is either a quartz glass tube preferably comprising a smooth inner wall produced in the melt flow, or a rod, such as e.g. a core rod.

The inner cylinder is provided in the known manner with a SiO₂ soot layer which is subsequently sintered in a sintering treatment. In contrast to the known methods, the sintering treatment is, however, not performed to such an extent that the soot layer is completely sintered into transparent quartz glass, but it is interrupted before the sintering zone that is progressing from the outside to the inside reaches the outer wall of the inner cylinder. A porous opaque intermediate layer which is surrounded at both sides by quartz glass is thereby formed on the outer wall of the inner cylinder. This procedure offers several advantages.
(1) The soot layer is sintered only in part during the sintering treatment. This yields a lower sintering temperature and/or a shorter sintering period, so that the necessary heating power is at any rate smaller than would be necessary for the complete and thorough sintering of the soot layer. It is noted that quartz glass acts as a thermal insulator and the sintered glassy layer acts as a barrier for the heating power proportion not transmitted by radiation, so that with the increasing thickness thereof more heating power is needed for continued sintering. Especially the outermost portion of the SiO₂ soot layer directly adjoining the outer wall of the inner cylinder thus requires maximum heating powers for transparent sintering so that the method according to the invention helps to save heating power.
(2) Since the sintering temperature is lower and/or the sintering duration is shorter, one additionally achieves a lower energy input into the inner cylinder. As a result, said cylinder is thermally less stressed. This is supported by the fact that the remaining pore-containing opaque intermediate layer considerably diminishes the transportation of radiation to the inner cylinder, thereby additionally protecting the inner cylinder against thermal loads. Thus, without any troublesome cooling measures as in the prior art, a deformation of the inner cylinder can be reliably prevented.
(3) Since the pore-containing intermediate layer leads to a reduced thermal load on the inner cylinder and reliably prevents deformation, the method according to the invention permits the use of a core rod as the inner cylinder without the risk of impairing this expensive component to be produced under great efforts.

The semifinished product produced according to the invention thereby shows a “sandwich structure” in radial direction, said sandwich structure being composed from the inside to the outside of a transparent inner cylinder of quartz glass, a partly sintered opaque intermediate layer and a transparent outer layer.

The semifinished product is provided for producing optical fibers. It is therefore subjected to one or a plurality of subsequent hot deformation processes, which are preferably elongation processes in which the semifinished product is elongated alone or together with other components into an optical fiber or into a preform for an optical fiber. The elongation process requires complete softening of the quartz glass of the semifinished product, and it has surprisingly been found that the opaque intermediate layer is converted into a bubble- and defect-free transparent quartz glass layer, i.e. fully into transparent quartz glass.

With respect to a complete sintering in subsequent hot treatments of the semifinished product, particularly during elongation of the semifinished product, it has turned out to be particularly advantageous when the sintering treatment is carried out at a negative pressure, with the pores of the intermediate layer being vacuoles.

Vacuoles are closed pores that in the subsequent hot treatment process will reliably collapse also during particularly short softening periods or at low softening temperatures, so that no cavities will remain.

Since the pores of the opaque boundary layer are formed by closed vacuoles, the semifinished product can be subjected to the standard cleaning processes without the risk that cleaning medium is introduced into the porous structure.

Alternatively, the sintering treatment is carried out under hydrogen or helium, with the pores of the intermediate layer containing hydrogen or helium.

Hydrogen and helium are gases that can diffuse particularly easily in quartz glass at high temperatures and can therefore still escape from closed pores by diffusion. The gas-filled pores can therefore collapse in a subsequent elongation process if the softening period is sufficiently long and/or the softening temperature sufficiently high.

It has turned out to be advantageous when the pores are formed with a mean pore diameter of less than 5 μm, preferably with a mean pore diameter of less than 3 μm.

The smaller the remaining pores of the intermediate layer are, the more reliably will they collapse during the hot deformation process of the semifinished product. Preferably, the mean pore diameter is therefore less than 2 μm. The pore diameter is set in the sintering treatment in that the sintering treatment is maintained for such a long time that the intermediate layer is thermally compacted to such an extent that only correspondingly small pores will remain. The maximum pore diameter should not exceed 20 μm because pores of such a large size necessitate a long heating period and/or a high heating temperature in the subsequent hot deformation process so as to ensure a complete collapsing. With very large pores there is also an increased risk that impurities will be introduced in subsequent hot deformation processes.

In this connection it has turned out to be advantageous when on average the SiO₂ soot layer has a relative density (based on the density of quartz glass) in the range of 25% to 30%.

It has been found that under the same sintering conditions (temperature and duration) the relative density of the soot layer has an effect on the diameter of the pores remaining in the intermediate layer. A relative density of the soot layer of less than 25% entails excessive shrinkage during sintering, and such shrinkage may in turn be accompanied by distortions and inhomogeneities that are difficult to eliminate in the subsequent hot deformation process. Surprisingly, initially high relative densities of the soot layer of more than 30% may have a similar effect. In this case regions of low gas permeability tend to form within the soot layer, and such regions impede a homogeneous dense sintering of the intermediate layer and may therefore also lead to coarse bubbles. A value of 2.21 g/cm³ is started from as the density of quartz glass.

It has turned out to be useful when the intermediate layer is formed with a mean thickness of not more than 50 mm, preferably with a mean thickness in the range of between 1 mm and 10 mm.

The thinner the remaining intermediate layer is, the more easily can it be removed completely in the subsequent hot deformation step. On the other hand, its effects as to the saving of energy and reduction of the thermal load on the inner cylinder are the more pronounced during the sintering treatment the thicker the intermediate layer is. At layer thicknesses of less than 1 mm these effects will hardly be noticed any more, so that the whole range between 1 mm and 50 mm represents an appropriate compromise.

In the event that a tubularly formed inner cylinder is used, it has turned out to be useful that said cylinder has a mean wall thickness in the range of 4 mm to 25 mm and an inner diameter in the range of 30 mm to 60 mm.

An inner tube is here used as the inner cylinder. Since the method of the invention avoids a softening and a deformation of the inner wall of the inner tube, the inner tube need no longer be subjected to a subsequent, troublesome and final machining operation, so that a tubular semifinished product of high geometric precision and surface quality of the inner bore can be obtained at low costs. The wall thickness of the inner cylinder is substantially determined by the weight and volume of the soot layer to be held. It is made as thick as needed for reasons of strength, and as thin as possible for reasons of costs. The indicated range of 4 mm to 25 mm is here an appropriate compromise, and in the case of a tubular inner cylinder that during deposition of the soot layer or in the sintering process is supported by means of a support body, for instance a graphite rod, which is introduced in the inner bore, a small wall thickness within the range of a few millimeters may be adequate. The method according to the invention permits the manufacture of a tubular semifinished product with a particularly small inner diameter.

Furthermore, it has turned out to be advantageous when the outer layer is produced with a mean thickness in the range of 10 mm to 150 mm.

The outer layer of dense transparent quartz glass stabilizes the semifinished product in subsequent further processing steps and it protects particularly the porous intermediate layer in subsequent hot treatment steps against the impact of the atmosphere. This function is promoted at a minimum thickness of the outer layer of 10 mm. By contrast, an outer layer with a thickness of more than 150 mm represents a kind of heat barrier that in subsequent hot deformation processes can impede a dense sintering of the porous intermediate layer.

The soot layer is sintered during the sintering treatment either in that the cylindrical semifinished product is heated zone by zone from a front end to the other end or in that the semifinished product is simultaneously heated over its entire length.

During zonewise sintering the gases that are present in the soot layer are driven in front of the inwardly progressing sintering front and can escape more easily from the still porous regions of the soot layer. This facilitates the setting of an intermediate layer with a small size of the closed pores.

It is intended in a particularly preferred modification of the method according to the invention that an inner cylinder of quartz glass is used which contains fluorine in the range of between 1,000 wt ppm and 15,000 wt ppm.

As is known, the addition of the dopant fluorine will lower both the refractive index and the viscosity of quartz glass. The comparatively lower viscosity of the fluorine-doped quartz glass can easily deform the inner cylinder during sintering. The method according to the invention reduces the heating impact on the inner cylinder during the sintering treatment, which permits the use of inner cylinders from thermally less stable quartz glass, e.g. a fluorine-doped quartz glass. The method of the invention is thus particularly well suited for producing semifinished products with a radially inhomogeneous refractive-index curve, particularly a stepped one.

With respect to the semifinished product, the above-mentioned object is achieved according to the invention in that it comprises an inner layer made of transparent synthetic quartz glass, an intermediate layer made of pore-containing synthetic quartz glass, and an outer layer made of transparent synthetic quartz glass, the pores being vacuoles or containing hydrogen or helium.

The semifinished product according to the invention is thus distinguished by a “sandwich structure” in which a portion of quartz glass of high porosity is enclosed between portions of transparent quartz glass. On account of the “sandwich-like” embedment of the porous layer between dense, transparent quartz glass, the semifinished product according to the invention can be subjected to the standard cleaning methods prior to its further processing, e.g. etching in a liquid etching solution or a treatment in an etching or cleaning atmosphere, without impurities from the cleaning agents or etchants being introducible into the porous intermediate layer.

The cylindrical semifinished product can be produced at low costs because of the above-described method, with the inner layer being less loaded thermally during the sintering treatment of the outer layer. The cylindrical semifinished product according to the invention is characterized by minor deviations from the cylinder symmetry and, in the case of a tubular semifinished product, by an inner bore of high dimensional stability.

The semifinished product serves the manufacture of an optical fiber or a preform for an optical fiber and is to be subjected to one or a plurality of hot deformation processes; an elongation process should here above all be mentioned in which the semifinished product is elongated alone or together with other components into an optical fiber or a preform for an optical fiber. Such an elongation process requires complete softening of the quartz glass of the semifinished product and it has surprisingly been found that the opaque layer is here converted into a defect-free transparent quartz glass layer, i.e., fully sintered into transparent quartz glass.

At least part of the cladding glass portion of the optical fiber or of the optical preform is formed by a semifinished product according to the invention. Hence, the semifinished product contributes to an inexpensive manufacture of a high-quality optical fiber.

With respect to a complete collapsing of the pores in a subsequent hot treatment or elongation process the pores of the intermediate layer are vacuoles or they contain hydrogen or helium. Vacuoles are closed pores that in the subsequent hot treatment process will reliably collapse also during particularly short softening periods or at low softening temperatures, so that no cavities will remain. Hydrogen and helium are gases that can diffuse particularly easily in quartz glass at high temperatures and can therefore still escape from closed pores by diffusion. The gas-filled pores can therefore collapse in a subsequent elongation process if the softening period is sufficiently long and/or the softening temperature sufficiently high.

With respect to a complete collapsing of the pores, it has turned out to be advantageous when the pores have a mean pore diameter of less than 5 μm, preferably a mean pore diameter of less than 3 μm.

The smaller the remaining pores of the intermediate layer are, the more reliably will they collapse during the hot deformation process. Preferably, the mean pore diameter is therefore less than 3 μm. The maximum pore diameter should not exceed 20 μm because pores of such a large size necessitate a long heating period and/or a high heating temperature in the subsequent hot deformation process so as to ensure a complete collapsing. With very large pores there is also an increased risk that impurities are introduced in subsequent hot deformation processes.

Preferably, the intermediate layer has a mean thickness of not more than 50 mm, preferably in the range of between 5 mm and 10 mm.

The thinner the intermediate layer is, the more easily can it be removed entirely in the subsequent hot deformation step.

Furthermore, it has turned out to be useful when the inner layer is made tubular and has a mean thickness in the range of 4 mm to 25 mm and an inner diameter in the range of 30 mm to 60 mm.

The semifinished tube is here made tubular and the inner layer is thus provided with an inner bore. Due to the comparatively low thermal load of the inner layer in the manufacture of the semifinished product the inner bore thereof is characterized by high geometric precision and surface quality. Complicated mechanical finishing treatments of the inner wall of the inner bore after the sintering process are not needed.

Furthermore, it has turned out to be advantageous when the outer layer has a mean thickness in the range of 10 mm to 150 mm.

The outer layer of dense transparent quartz glass stabilizes the semifinished product during its further processing and it protects particularly the porous intermediate layer in subsequent hot treatment steps against the impact of the atmosphere. This effect is promoted by a minimum thickness of the outer layer of 10 mm. At thicknesses of the outer layer of more than 150 mm, this constitutes a certain heat barrier in subsequent hot deformation processes that can impede a dense sintering of the porous intermediate layer.

A particularly preferred embodiment of the semifinished product is characterized in that that the inner layer consists of quartz glass that contains fluorine in the range of between 1,000 wt ppm and 15,000 wt ppm.

As is known, the addition of the dopant fluorine will lower both the refractive index and the viscosity of quartz glass. The comparatively lower viscosity of the fluorine-doped quartz glass can easily deform the inner layer during heating for sintering the outer layer. The above-explained method according to the invention reduces the heating impact on the inner layer of the semifinished product during the sintering treatment, so that it is possible to obtain a semifinished product with a geometrically precise and dimensionally stable inner layer even if said layer consists of a thermally less stable quartz glass, e.g. a quartz glass doped with fluorine. With an outer layer and an intermediate layer of undoped quartz glass the semifinished product according to the invention thus exhibits a radially inhomogeneous stepwise refractive index curve. Such a semifinished product is particularly suited for the production of so-called bending-insensitive optical fibers that are characterized by a jacket portion with a lowered refractive index.

### EMBODIMENT

The invention will now be explained with reference to embodiments and a drawing in more detail. The schematic illustration shows in detail in

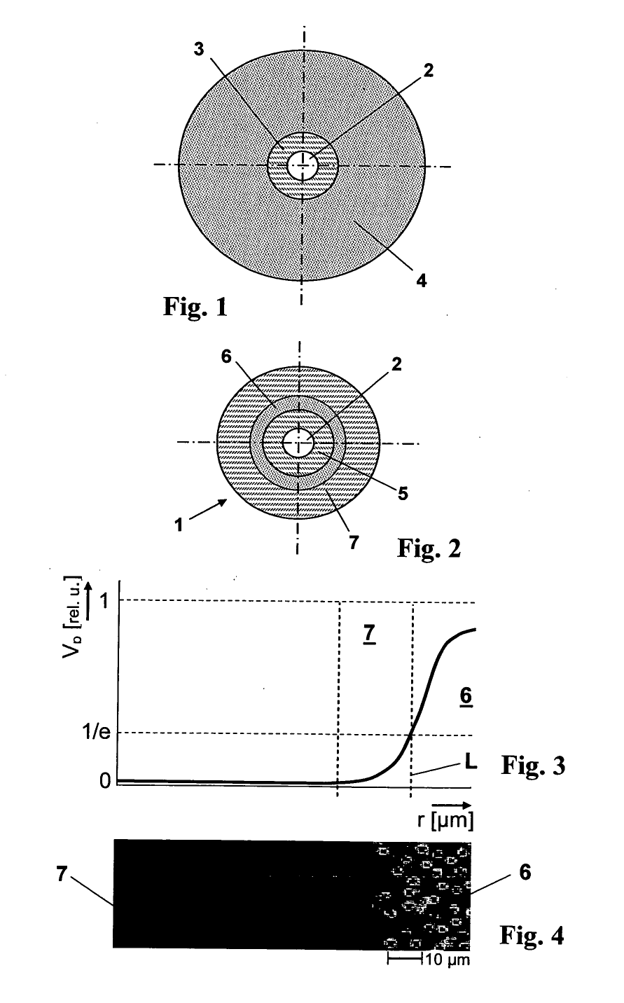

FIG. 1 a radial cross-section of an inner tube of quartz glass coated with a SiO₂ soot layer prior to sintering of the SiO₂ soot layer;

FIG. 2 a radial cross-section of the inner tube of quartz glass coated with the SiO₂ soot layer after sintering of the SiO₂ soot layer;

FIG. 3 a diagram in a schematic view with the radial profile of the pore volume in the area of the boundary between outer layer and intermediate layer in the semifinished product according to the invention; and

FIG. 4 schematically a top view on the area of the boundary between outer layer and intermediate layer in the semifinished product according to the invention.

FIG. 1 is a schematic illustration showing an inner tube 3 of synthetic quartz glass on which a SiO₂ soot layer 4 has been deposited according to the known OVD method. The inner tube 3 has an inner bore 2 with an inner diameter of 50 mm and a wall thickness of 10 mm. The soot layer 4 has a thickness of about 150 mm at a mean density of about 27%.

The inner tube 3 which is coated with the SiO₂ soot layer 4 is subjected to a sintering treatment, as a result of which one obtains the semifinished product 1 shown in FIG. 2 according to the invention.

The semifinished product 1 invariably shows the inner bore 2 with an inner diameter of 50 mm which is surrounded by an inner layer 5 of synthetic quartz glass with a layer thickness of 10 mm, the inner layer 5 being formed from the synthetic quartz glass of the original inner tube 3.

An intermediate layer 6 of pore-containing quartz glass adjoins the inner layer 5 to the outside, and an outer layer 7 of transparent quartz glass adjoins the intermediate layer 6. Intermediate layer 6 and outer layer 7 are made from the synthetic SiO₂ of the original soot layer 4. The outer layer 7 forms a fully densely sintered portion of the original soot layer 4, and the intermediate layer 6 forms a pore-containing portion of the soot layer 4 that is not completely sintered. The intermediate layer has a mean layer thickness of about 5 mm and the outer layer has a mean layer thickness of about 61 mm. Hence, the outer diameter of the cylindrical semifinished product 1 is about 202 mm on the whole.

The boundary between the inner layer 5 and the intermediate layer 6 is readily discernible and defined as a sharp transition between opaque and transparent quartz glass. By contrast, due to the manufacturing process a small transition portion in which the pore volume rises from zero to 100% is formed between the outer layer 7 and the intermediate layer 6. The line where the pore volume is about 37% (1/e) of the maximum pore volume (100%) is defined as the boundary between these two portions, as shall be explained in more detail hereinafter with reference to FIGS. 3 and 4.

The method according to the invention for producing the semifinished product illustrated in FIG. 2 will be explained by way of example hereinafter.

A hollow cylinder of synthetic quartz glass that is commercially obtainable under the designation “F300” from Heraeus Quarzglas GmbH & Co. KG is elongated in a vertical drawing process without any tool, and the inner tube 3 is obtained therefrom with an outer diameter of 70 mm, an inner diameter of 50 mm and a wall thickness of 10 mm. The quartz glass of the inner tube has a typical hydroxyl group content of less than 0.2 wt. ppm and a chlorine content of less than 2500 wt. ppm.

The SiO₂ soot layer 4 is produced on the inner tube 3 of quartz glass by outside vapor deposition (OVD). SiO₂ particles are formed by flame hydrolysis of SiCl₄ and are deposited layer by layer on the outer jacket of the inner tube 3 rotating about its longitudinal axis, so that a porous SiO₂ soot layer 4 with a layer thickness of about 150 mm and a relative density of 27% (based on the density of undoped quartz glass) is formed on the inner tube 3.

To reduce the hydroxyl group content of the soot layer 4 to a value of less than 0.5 wt. ppm, the coated inner tube 3 is subjected to a dehydration treatment that includes a treatment for 6 hours under nitrogen at a temperature of 900° C. and subsequent treatment in a chlorine-containing atmosphere at a temperature of 900° C. for a period of 8 hours.

Subsequently, the porous SiO₂ soot layer 4 is sintered in a vertical zone sintering method. To this end the inner tube 3 provided with the soot layer 4 is introduced into a vacuum furnace and is supplied under vacuum (pressure <2 mbar), starting with the lower end, continuously and at a feed rate of 3 mm/min to a stationary annular short heating zone, and the soot layer 4 is here sintered zonewise from the bottom to the top and simultaneously from the outside to the inside. The temperature in the heating zone is about 1,500° C.

Feed rate and temperature are chosen such that the sintering front traveling from the outside to the inside produces a completely densely sintered transparent outer layer 7 and a further interior opaque intermediate cylinder 6 which adjoins the inner layer 6 and is not completely densely sintered and contains the vacuoles. The mean diameter of the vacuoles is about 1 μm and the relative density of the intermediate layer 6 is about 99% of the density of quartz glass.

The layer thicknesses of outer layer 7 and intermediate layer 6 are reduced by sintering to about 56 mm, resulting in a hollow cylinder of quartz glass with an outside diameter of about 202 mm.

The inner diameter and the wall thickness of the inner, layer 4 of the semifinished product 1 obtained in this way correspond to the dimensions of the original inner tube 3. The measurement of the inner diameter over the whole length of the inner bore showed a maximum deviation from the mean value and from the original diameter value of less than 0.2 mm.

FIG. 4 schematically shows a top view on the transition portion between outer layer 7 and intermediate layer 6 in the semifinished product 1 of the invention. The vacuoles of the intermediate layer 6 can be made out as black dots. The mean size of the vacuoles is clearly below 2 μm. Vacuoles with a diameter of more than 10 μm are not present.

In the diagram of FIG. 3 the pore volume Vₚ (in relative units) in the transition portion between outer layer 7 and intermediate layer 6 is schematically plotted against the radius (r) of the semifinished product 1. It has been found that the pore volume rises within a relatively small portion from zero to the maximum value, as is also found in close vicinity to the inner layer 5. Line “L” at which the mean pore volume has reached a value of 1/e is defined as the boundary between outer layer 7 and intermediate layer 6.

After the sintering process the semifinished product 1 is cleaned and the inner wall is acidified in hydrofluoric acid, with a layer of about 30 μm being etched off from the inner wall 7. The semifinished product 1 is then provided in a known rod-in-tube method with a core rod and elongated into a preform. The pores of the intermediate layer 6 collapse completely, resulting in a portion of transparent quartz glass.

In an alternative procedure, and instead of an inner tube 3 of undoped quartz glass, use is made of an inner tube of a quartz glass that is doped with about 3,500 wt. ppm fluorine. Such a quartz glass tube is commercially obtainable under the name “F320” from Heraeus Quartzglas GmbH & Co. KG. The inner tube of fluorine-doped quartz glass is further processed in the way as has been explained above with reference to the embodiment.

A tubular semifinished product with a radially inhomogeneous stepped refractive index curve is obtained that is distinguished particularly by a geometrically precise and dimensionally stable inner bore. Bending-insensitive optical fibers are made from the semifinished product in that it is provided in a rod-in-tube method with a core rod and directly elongated into the optical fiber. The pores of the intermediate layer will thereby collapse completely.

1. A method for producing an optical component by elongating a cylindrical semifinished product of synthetic quartz glass, the method comprising:
cladding an inner cylinder of synthetic quartz glass comprising having an outer wall with a SiO₂ soot layer;
subjecting the SiO₂ soot layer to a sintering treatment in which the SiO₂ soot layer is heated from the outside, and a sintering zone thereby moves through the SiO₂ soot layer from an outside thereof to an inside thereof so as to form an outer layer of transparent quartz glass;
interrupting the sintering treatment before the sintering zone reaches the outer wall of the inner cylinder so as to form a semifinished product in which an intermediate layer of synthetic quartz glass having pores therein remains between the outer layer and the outer wall of the inner cylinder; and
elongating the semifinished product so as to form the optical component, with the intermediate layer being completely sintered into transparent quartz glass.

2. The method according to claim 1, wherein the sintering treatment is carried out at a negative pressure and the pores of the intermediate layer are vacuoles.

3. The method according to claim 1, wherein the sintering treatment is performed under a hydrogen or helium atmosphere and the pores of the intermediate layer contain hydrogen or helium.

4. The method according to claim 1, wherein the pores are formed with a mean pore diameter of less than 5 μm.

5. The method according to claim 1, wherein on-average the SiO₂ soot layer has an average relative density (based on the density of quartz glass=2.21 g/cm³) in a range of 25% to 30%.

6. The method according to claim 1, wherein the intermediate layer is formed with a mean thickness of not more than 50 mm.

7. The method according to claim 1, wherein an inner cylinder is shaped as a tube and has a mean wall thickness in a range of 4 mm to 25 mm and an inner diameter in a range of 30 mm to 60 mm.

8. The method according to claim 1, wherein the outer layer is produced with a mean thickness in a range of 10 mm to 150 mm.

9. The method according to claim 1, wherein an inner cylinder of quartz glass is used that contains fluorine in a range between 1,000 wt ppm and 15,000 wt ppm.

10. A cylindrical semifinished product for producing an optical component, said cylindrical semifinished product comprising: an inner layer made of transparent synthetic quartz glass, an intermediate layer made of pore-containing synthetic quartz glass, and an outer layer made of transparent synthetic quartz glass, the pores being vacuoles containing hydrogen or helium.

11. The semifinished product according to claim 10, wherein the pores have a mean pore diameter of less than 5 μm.

12. The semifinished product according to claim 10, wherein the intermediate layer has a mean thickness of 50 mm at the most.

13. The semifinished product according to claim 10, wherein the inner layer is tubular shaped and has a mean thickness in a range of 4 mm to 25 mm and mean an inner diameter in a range of 30 mm to 60 mm.

14. The semifinished product according to claim 10, wherein the outer layer has a mean thickness in a range of 10 mm to 150 mm.

15. The semifinished product according to claim 10, wherein the inner layer consists of quartz glass containing fluorine in a range between 1,000 and 15,000 wt ppm.

16. The method according to claim 1, wherein the pores are formed with a mean pore diameter of less than 3 μm.

17. The method according to claim 1, wherein the intermediate layer is formed with a mean thickness in a range between 1 mm and 10 mm.

18. The semifinished product according to claim 10, wherein the pores have a mean pore diameter of less than 3 μm.

19. The semifinished product according to claim 10, wherein the intermediate layer has a mean thickness in a range between 1 mm and 10 mm.
